(19) United States
(12) Patent Application Publication
(10) Pub. No.: US 2013/0167541 A1
(43) Pub. Date: Jul. 4, 2013

(54) Air-Fuel Premixer for Gas Turbine Combustor with Variable Swirler

(71) Applicants: Mahesh Bathina, Karnataka (IN); Amulya Panda, Bangalore (IN)

(72) Inventors: Mahesh Bathina, Karnataka (IN); Amulya Panda, Bangalore (IN)

(21) Appl. No.: 13/342,645

(22) Filed: Jan. 3, 2012

(51) Int. Cl. F02C 7/22

(52) U.S. Cl. 60/738; 60/748

(57) ABSTRACT

A swirler assembly in a gas turbine combustor includes a hub, a shroud, and a plurality of vanes connected between the hub and the shroud. A vane angle of the plurality of vanes is adjustable.

### BACKGROUND OF THE INVENTION

The present invention relates to gas turbines and, in particular, to an air-fuel premixer for a gas turbine combustor with a variable swirler.

Gas turbine engines generally include a compressor for compressing an incoming airflow. The airflow is mixed with fuel and ignited in a combustor for generating hot combustion gases. The combustion gases in turn flow to a turbine. The turbine extracts energy from the gases for driving a shaft. The shaft powers the compressor and generally another element such as an electrical generator.

Gas turbine output varies based on many factors, one of which is fuel type. Lower reactivity fuels typically have lower flame speed, and as a consequence, the flow rate of the fuel and compressed working mixture from the primary nozzles is sufficiently high so that combustion in the upstream chamber occurs at a sufficient distance from the primary nozzles to prevent the combustion from excessively heating and/or melting the primary nozzles. Higher reactivity fuels, however, have higher flame speeds. Increased flame speeds can move the combustion in the upstream chamber closer to the primary nozzles. Local flame temperature in the upstream chamber using higher reactivity fuels could result in premature or catastrophic failure of the component.

In the current swirler or swozzle set up, at base load or any given load condition, average axial velocities in the burner tube exit remain constant. The axial and tangential velocity components depend on swirler vane angle. The desired axial velocities at the burner tube exit are determined from flame speeds of a particular fuel composition (e.g., 30 ft/s safety margin at the burner tube exit).

It would be desirable to control axial velocities in the burner tube to aid in operating the machine over an extended operating range for various fuel compositions.

### BRIEF DESCRIPTION OF THE INVENTION

In an exemplary embodiment, a swirler assembly in a gas turbine combustor includes a hub, a shroud, and a plurality of vanes connected between the hub and the shroud. A vane angle of the plurality of vanes is adjustable.

In another exemplary embodiment, a burner for use in a combustion system of a gas turbine includes a fuel/air premixer having an air inlet, a fuel inlet, and an annular mixing passage. The fuel/air premixer mixes fuel and air in the annular mixing passage into a uniform mixture for injection into a combustor reaction zone. The fuel/air premixer includes a swirler assembly downstream of the air inlet. The swirler assembly includes a hub, a shroud, and a plurality of vanes connected between the hub and the shroud that impart swirl to the incoming air. A vane angle of the plurality of vanes is adjustable. The burner also includes an inlet flow conditioner disposed at the air inlet of the fuel/air premixer upstream of the fuel inlet.

In yet another exemplary embodiment, a swirler assembly in a gas turbine combustor includes a hub, a shroud, and a plurality of vanes connected between the hub and the shroud. A vane angle of the plurality of vanes is adjustable. Each of the plurality of vanes includes a fixed section secured between the hub and the shroud and a movable section movably secured to the fixed section. At least one of the plurality of vanes includes a fuel passage.

### BRIEF DESCRIPTION OF THE DRAWINGS

FIG. 1 is a side cross-sectional view of a gas turbine swirler;

FIG. 2 is a perspective view of a swirler assembly;

FIG. 3 shows varying vane angles for the swirler assembly;

FIGS. 4 and 5 show a purge passage;

FIG. 6 shows a fuel injection vane; and

FIG. 7 shows an alternative embodiment.

### DETAILED DESCRIPTION OF THE INVENTION

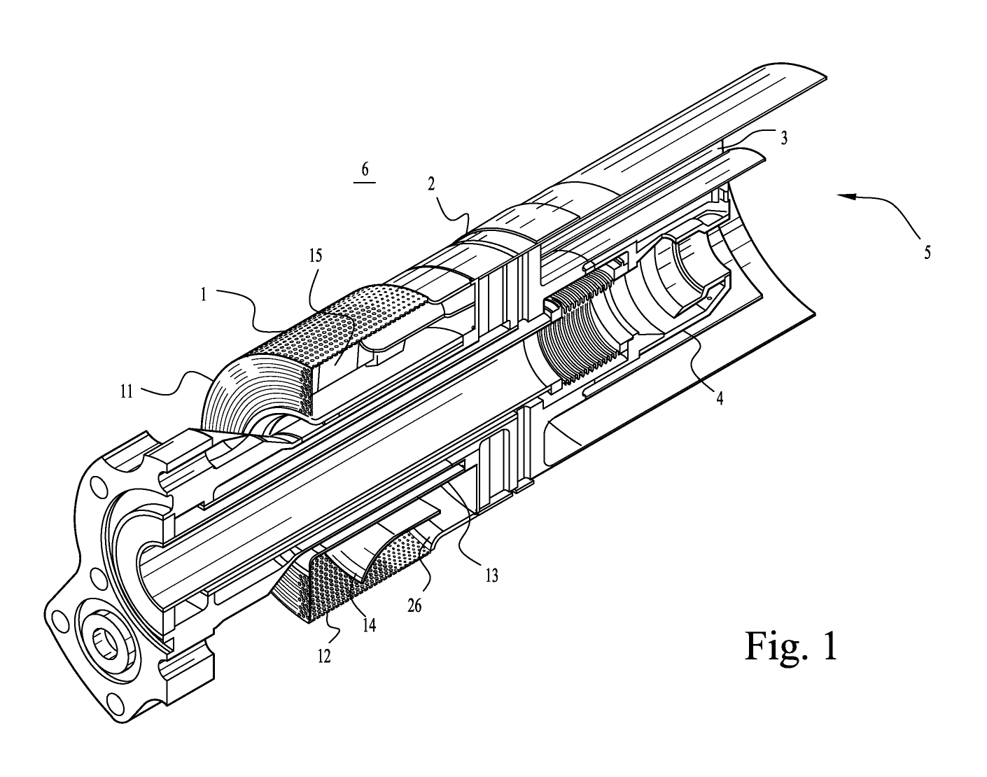

FIG. 1 is a cross-section through a burner tube in a gas turbine. The burner assembly is divided into four regions by function including an inlet flow conditioner 1, an air swirler assembly (referred to as a swozzle assembly) 2, an annular fuel air mixing passage 3, and a central diffusion flame fuel nozzle assembly 4.

Air enters the burner from a high pressure plenum 6, which surrounds the entire assembly except the discharge end, which enters the combustor reaction zone 5. Most of the air for combustion enters the premixer via the inlet flow conditioner (IFC) 1. The IFC includes an annular flow passage 15 that is bounded by a solid cylindrical inner wall 13 at the inside diameter, a perforated cylindrical outer wall 12 at the outside diameter, and a perforated end cap 11 at the upstream end. In the center of the flow passage 15 is one or more annular turning vanes 14. Premixer air enters the IFC 1 via the perforations in the end cap and cylindrical outer wall.

The perforated walls 11, 12 perform the function of backpressuring the system and evenly distributing the flow circumferentially around the IFC annulus 15, whereas the turning vane(s) 14 work in conjunction with the perforated walls to produce proper radial distribution of incoming air in the IFC annulus 15. Depending on the desired flow distribution within the premixer as well as flow splits among individual premixers for a multiple burner combustor, appropriate hole patterns for the perforated walls are selected in conjunction with axial position of the turning vane(s) 14.

To eliminate low velocity regions near the shroud wall 202 at the inlet to the swozzle 2, a bell-mouth shaped transition 26 may be used between the IFC and the swozzle.

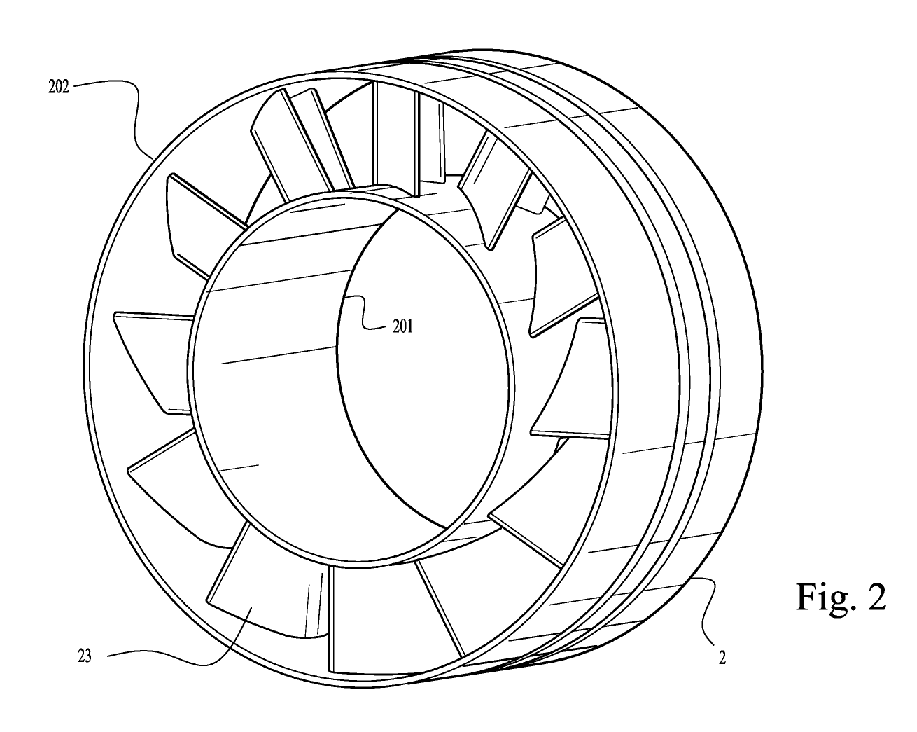

After combustion air exits the IFC 1, it enters the swozzle assembly 2. The swozzle assembly includes a hub 201 (FIG. 2) and a shroud 202 connected by a series of air foil shaped turning vanes 23, which impart swirl to the combustion air passing through the premixer. After exiting the annular passage 3, the fuel/air mixture enters the combustor reaction zone 5 where combustion takes place.

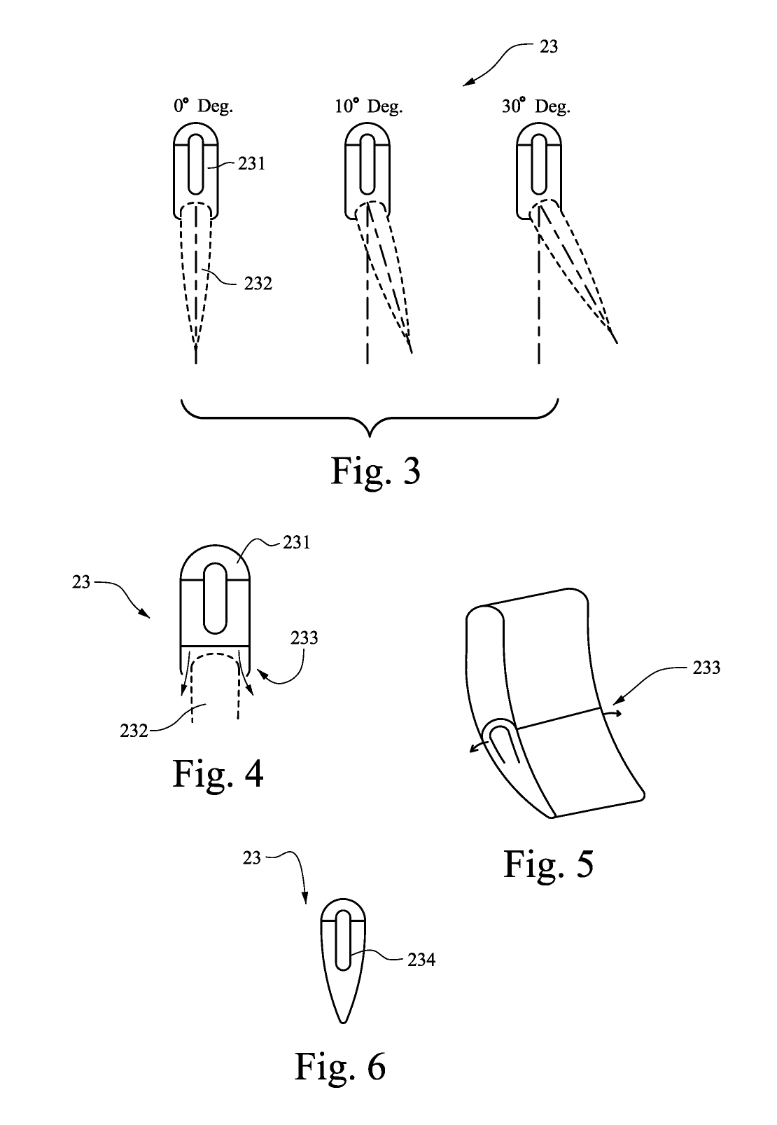

The swirler assembly according to exemplary embodiments serves to control the axial velocities in the burner tube to aid in operating gas turbines over an extended operating range for various fuels. The swirler assembly serves to enhance fuel flexibility and extended operability. With reference to FIG. 3, the vanes 23 of the swirler assembly include a fixed section 231 secured between the hub and the shroud and a movable section 232 movably secured to the fixed section 231. The movable section 232 is adjustable to change a vane angle of the vane 23. FIG. 3 shows exemplary orientations with the vane angle at 0°, 10° and 30°. Preferably, the movable section is positionable relative to the fixed section between vane angles of 0°-60°.

With a straight vane, a tangential component of the velocity is almost negligible, while axial velocity represents the bulk of the velocity magnitude. As the vane angle increases, axial velocity decreases and tangential velocity increases.

With reference to FIGS. 4 and 5, each of the adjustable angle swirler vanes 22 includes a purge passage 233 between the fixed section 231 and the movable section 232. The passage between movable and non-movable parts are potential regions for flame holding due to flow separation and thereafter more likely to form recirculation zones. These regions are purged with non-ignitable fluids as such air or diluents continuously to avoid flame holding.

With reference to FIG. 6, one or several of the swirler vanes may include a fuel passage 234 for injecting fuel into the air flow. The fuel injection vane can be interposed amongst the vanes in various configurations including interposed between vanes without the fuel passage.

Preferably, the vane angle is set to the same angle for each of the plurality of vanes 23. Vane angle can be set using conventional structure such as the structure used for controlling inlet guide vanes (IGVs) of a gas turbine. See, for example, U.S. Pat. No. 7,985,053, FIGS. 1 and 2. Preferably, the vane angle is determined according to a type of fuel input to the gas turbine. That is, based on the fuel composition, an optimum angle for the swirler vanes can be set before turbine start up to give enough safety margin for reliable operation. The vane angle may also be determined according to ambient conditions in which the gas turbine is operating. Still further, the vane angle may be changed while the system is running.

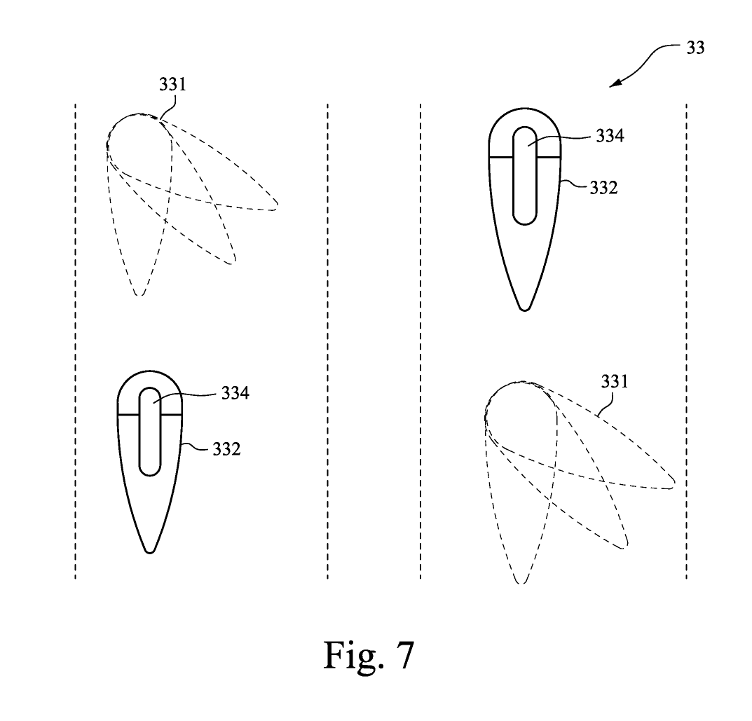

In an alternative embodiment, with reference to FIG. 7, a swirler vane 33 can be split into a combination of two individual vanes 331, 332 with a movable vane 331 placed either before or after a vane 332 including fuel injection. The fuel injection vane 332 includes a fuel plenum 334 inside the vane, which is connected to an air passage between the vanes. The connection may be effected by multiple pegs on the pressure side and suction side of the vane. The method of injecting fuel may also be carried out through fuel holes placed on the hub or shroud or through pegs projected from the shroud/hub.

The variable swirler angle addresses flame holding issues (inside the premixer) and serves to stabilize the flame in the combustion zone for a wide range of fuel compositions by suitably varying axial velocities.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A swirler assembly in a gas turbine combustor, the swirler assembly comprising:
a hub;
a shroud; and
a plurality of vanes connected between the hub and the shroud, wherein a vane angle of the plurality of vanes is adjustable.

2. A swirler assembly according to claim 1, wherein each of the plurality of vanes comprises a fixed section secured between the hub and the shroud and a movable section movably secured to the fixed section.

3. A swirler assembly according to claim 2, wherein the movable section is positionable relative to the fixed section between vane angles of 0°-60°.

4. A swirler assembly according to claim 2, further comprising a purge passage between the fixed section and the movable section.

5. A swirler assembly according to claim 1, wherein at least one of the plurality of vanes includes a fuel passage.

6. A swirler assembly according to claim 5, wherein several of the plurality of vanes includes the fuel passage, and wherein the vanes including the fuel passage are interposed between vanes without the fuel passage.

7. A swirler assembly according to claim 1, further comprising fuel injection vanes interposed between respective ones of the plurality of vanes.

8. A swirler assembly according to claim 1, wherein the vane angle is the same for each of the plurality of vanes.

9. A swirler assembly according to claim 1, wherein the vane angle is determined according to a type of fuel input to the gas turbine.

10. A swirler assembly according to claim 9, wherein the vane angle is also determined according to ambient conditions in which the gas turbine is operating.

11. A burner for use in a combustion system of a gas turbine, the burner comprising:
a fuel/air premixer having an air inlet, a fuel inlet, and an annular mixing passage, the fuel/air premixer mixing fuel and air in the annular mixing passage into a uniform mixture for injection into a combustor reaction zone, wherein the fuel/air premixer comprises a swirler assembly downstream of the air inlet, the swirler assembly including a hub, a shroud, and a plurality of vanes connected between the hub and the shroud that impart swirl to the incoming air, wherein a vane angle of the plurality of vanes is adjustable; and
an inlet flow conditioner disposed at the air inlet of the fuel/air premixer upstream of the fuel inlet.

12. A burner according to claim 11, wherein each of the plurality of vanes comprises a fixed section secured between the hub and the shroud and a movable section movably secured to the fixed section.

13. A burner according to claim 12, wherein the movable section is positionable relative to the fixed section between vane angles of 0°-60°.

14. A burner according to claim 12, further comprising a purge passage between the fixed section and the movable section.

15. A burner according to claim 11, wherein at least one of the plurality of vanes includes a fuel passage.

16. A burner according to claim 15, wherein several of the plurality of vanes includes the fuel passage, and wherein the vanes including the fuel passage are interposed between vanes without the fuel passage.

17. A burner according to claim 11, wherein the vane angle is determined according to a type of fuel input to the gas turbine.

18. A burner according to claim 17, wherein the vane angle is also determined according to ambient conditions in which the gas turbine is operating.

19. A swirler assembly in a gas turbine combustor, the swirler assembly comprising:
a hub;
a shroud; and
a plurality of vanes connected between the hub and the shroud, wherein a vane angle of the plurality of vanes is adjustable, wherein each of the plurality of vanes comprises a fixed section secured between the hub and the shroud and a movable section movably secured to the fixed section, and wherein at least one of the plurality of vanes includes a fuel passage.

20. A swirler assembly according to claim 19, further comprising a purge passage between the fixed section and the movable section.
